(19) United States
(12) Patent Application Publication
(10) Pub. No.: US 2025/0304888 A1
(43) Pub. Date: Oct. 2, 2025

(54) SLOW RELEASE TOILET CLEANSING TABLET

(71) Applicant: Henkel AG & Co. KGaA, Duesseldorf (DE)

(72) Inventor: Daniel Thomas Piorkowski, Fairfield, CT (US)

(21) Appl. No.: 18/986,091

(22) Filed: Dec. 18, 2024

Related U.S. Application Data
(60) Provisional application No. 63/619,419, filed on Jan. 10, 2024.

(51) Int. Cl. C11D 3/395; A47K 17/00; C11D 3/22; C11D 3/30; C11D 17/00

(52) U.S. Cl. CPC C11D 3/3953; A47K 17/00; C11D 3/222; C11D 3/30; C11D 17/0073

(57) ABSTRACT

A solid slow-release formulation effective as a toilet cleanser, comprising a highly branched cyclic dextrin (i.e., cyclic dextrin) and a binder is provided. The solid cleansing formulation contains at least one cyclic dextrin and a binder, and optionally, one or more dissolution control agents, one or more surfactants, one or more pH adjusters or buffers, one or more cleaning actives, fragrances, and/or colorants. Notably, the solid cleansing formulation can reduce or even eliminate bathroom malodors over time by placing the solid cleansing formulation in a toilet tank. The solid cleansing formulation is designed to slowly dissolve over time and release its contents into the toilet flushing water with each flush.

### CROSS REFERENCE TO RELATED APPLICATION

The present invention claims the benefit of U.S. Provisional Patent Application No. 63/619,419 filed Jan. 10, 2024, the entire content and disclosure of which is incorporated herein by reference.

### BACKGROUND

The present disclosure generally relates to toilet cleansing formulations, and more particularly, to solid cleansing tablets having a slow release property and suited for placement in a toilet tank to cleanse a toilet bowl with each flush.

Bathroom malodor is one of the most prevalent malodors which consumers seek to address by using various air care and water tank products in the bathroom. The chemical constituents in bathroom malodor, predominantly short-chained fatty acids, mercaptans, indoles, urea, and organoamines, build up over time and persist on toilet bowl surfaces and may continue to be perceivable even after washing or treatment with conventional cleansing products. It is therefore critical to identify new approaches to neutralize these malodors to provide enhanced benefits. There is a particular need for formulations and methods for reducing or eliminating bathroom malodors, particularly those that tend to persist after conventional washing or treatment.

### SUMMARY

The present disclosure is foremost directed to a toilet cleansing tablet that includes a highly branched cyclic dextrin (i.e., “cyclic dextrin”) as a key component for reducing or eliminating bathroom malodor arising from the toilet bowl. The cleansing tablet contains (i.e., comprises, consists of, or consists essentially of) the cyclic dextrin and a binder. The cleansing tablet may further contain a dissolution control agent to promote the slow (rather than sudden) release of the components in the tablet. The cleansing tablet may optionally also contain a fragrance component, colorant, one or more surfactants (e.g., cationic, anionic, or non-ionic), one or more pH adjusting compounds, and/or one or more pH buffers.

In another aspect, the present disclosure is directed to a method of using the above described toilet cleansing tablet. The toilet cleansing tablet is designed to be dropped or suspended into a toilet tank or toilet bowl where it slow releases its components, including the cyclic dextrin, into the water used for flushing. The toilet cleansing tablet can be used along with or in place of regular manual washing, treatment, or scrubbing of the toilet bowl.

### BRIEF DESCRIPTION OF THE DRAWINGS

FIGS. 1A, 1B, and 1C depicts highly-branched cyclic dextrin from amylose as line structure (1A), molecular structure (1B), and 3D structure (1C).

### DETAILED DESCRIPTION

The present disclosure will now be described in greater detail by referring to the following discussion and drawings that accompany the present disclosure. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. As used throughout the present disclosure, the term “about” generally indicates no more than ±10%, ±5%, ±2%, ±1% or ±0.5% from a number. When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) or any in amount that is bounded by any of the two values that can be present within the range (e.g., 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof.

### Slow Release Tablet Formulation

The present disclosure provides a solid slow-release formulation effective as a toilet cleanser that includes (i.e., comprises, consists essentially of, or consists of) a highly branched cyclic dextrin (hereinafter, “cyclic dextrin”) and a binder. The toilet cleanser is typically a compressed solid in the shape of a tablet or block having any suitable shape (e.g., cube, rectangle, oval, or sphere). The solid cleansing formulation may include one or more features to permit it to be suspended in the water of the toilet tank. For example, the solid cleansing formulation may be affixed to or suspended on a clip made to hang in a toilet tank. In other embodiments, the solid cleansing formulation is not adorned with any such device and is made to simply drop into the toilet tank.

In some embodiments, the solid cleansing formulation includes one or more additional components useful in toilet care, such as one or more of a dissolution control agent, colorant, dispersant, fragrance, enzyme, bleach, filler, dye, an alcoholic solvent, or the like. The alcoholic solvent may be, for example, ethanol, or a glycol, such as, for example, propylene glycol, dipropylene glycol, glycerol, or a combination thereof. In some embodiments, the solid cleansing formulation excludes any one or more of the above components.

### Highly-Branched Cyclic Dextrin (Cyclic Dextrin)

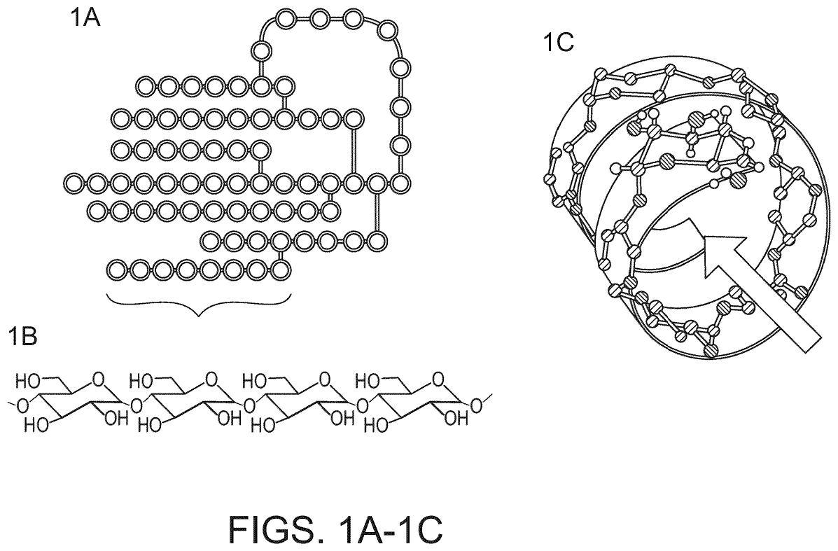

FIGS. 1A, 1, and 1C depict highly-branched cyclic dextrin from amylose as line structure (1A), molecular structure (1B), and 3D structure (1C). Dextrin is a polymer of glucose and is produced by a method of enzymatically decomposing a starch, such as amylopectin (for example corn starch). Depending on the enzyme treatment conditions in the manufacturing process, for example, the type and amount of the enzyme, the degree and form of decomposition may be manipulated to produce certain forms, such as branching and molecular weight, of dextrin. Highly-branched cyclic dextrin is one form of dextrin that may be produced in this manner (see portion “A” of FIG. 1), using a cyclization reaction of a branching enzyme (BE,1,4-α-D-glucan: 1,4-α-D-glucan 6-α-D-(1,4-α-D-glucano)-transferase, EC 2.4.1.18). Cyclic dextrin is dextrin characterized in that 6 to 16 glucoses are linked by α-1,4 bonds (see portion “B” of FIG. 1). One example of a cyclic dextrin is α-cyclodextrin, which contains six glucoses. In another example, β-cyclodextrin contains seven glucoses, and as another example, γ-cyclodextrin contains eight glucoses. Without being bound by any theory, the cyclic dextrin can be in the shape of a coil or a helical structure (see portion “C” of FIG. 1). Commercially available highly-branched cyclic dextrin is in the form of a white powder, is soluble in water, and has a loss on drying of less than about 5.5%. In embodiments of the present application, the highly-branched cyclic dextrin is maltodextrin.

The bonds between the glucoses allow cyclic dextrin to have the coil-like or helical-like structure shown in FIG. 1, containing a certain volume of void space. The array of each interior space is formed by oxygen atoms that form glycoside bridges with hydrogen atoms. Therefore, the inner surface becomes very hydrophobic, and the specific shape and physico-chemical properties of the voids have structural features capable of absorbing organic molecules or portions of organic molecules that match the shape of the inner space of the cyclic dextrin. The outside of the cyclic dextrin, however, remains hydrophilic. In this manner, malodors may be entrapped within the voids and effectively removed from the toilet bowl surface.

The highly-branched cyclic dextrin compounds (i.e., “cyclic dextrin”) can have an average molecular weight, in embodiments, from about 100 kilo Daltons to about 5000 kilo Daltons, or for example, from about 500 kilo Daltons to about 3000 kilo Daltons. Moreover, the cyclic dextrin can be included within the solid cleansing formulation of the present disclosure, in embodiments, in an amount of from about 0.05 weight percent to about 10.0 weight percent, for example, from about 0.1, 0.2, or 0.5 weight percent to about 5.0 weight percent, or from about 1.0 weight percent to about 3.0 weight percent. In certain embodiments, the cyclic dextrin can be included within the solid cleansing formulation of the present disclosure in an amount from about 0.1, 0.2, 0.5, or 1 weight percent to about 2, 3, 4, or 5 weight percent. All weight percentages used herein are by total weight of the solid cleansing formulation, unless otherwise specifically noted.

In one embodiment, the cyclic dextrin is present in the solid cleansing formulation in an amount from about 0.01 percent by weight to about 10.0 percent by weight based on the total weight of the solid formulation. In another embodiment, the cyclic dextrin is present in an amount from about 0.02 percent by weight to about 5.0 percent by weight based on the total weight of the formulation. In yet another embodiment, the cyclic dextrin is present in an amount from about 1 percent by weight to about 3.0 percent by weight based on the total weight of the formulation. In various embodiments, the cyclic dextrin is present in the solid cleansing formulation in an amount of precisely or about, for example, 0.1, 0.15, 0.2, 0.5, 1, 2, 4, 5, 6, 7, 8, 9, or 10 wt %, or in an amount within a range bounded by any two of the foregoing values, e.g., 0.1-10 wt %, 0.5-10 wt %, 1-10 wt %, 2-10 wt %, 0.1-5 wt %, 0.5-5 wt %, 1-5 wt %, 2-5 wt %, 0.1-2 wt %, 0.5-2 wt %, 1-2 wt %, 0.1-1 wt %, 0.5-1 wt %, 0.1-0.5 wt %, or 0.1-0.2 wt %.

### Binder

The binder provides structural integrity and a shape to the solid cleansing formulation and aids in the slow release of the components. The binder may be or include, for example, a hydroxyalkylcellulose, such as hydroxyethylcellulose. Other compounds may be useful alone or in combination with other binding agents to function as a binder. Some other compounds that may be used as binders include sodium sulfate, sodium carbonate, trisodium citrate, C₁₀₋₁₆ linear alkyl sulfonates, C₁₀₋₁₆ linear alkyl-benzene sulfonates, alkyl polyglucosides, and combinations thereof.

### Dissolution Control Agents

The solid cleansing formulation may include a dissolution control agent. The dissolution control agent may be, for example, a monoalkanolamine (e.g., monoethanolamine) or a mono- or di-alkanol amide derived from C₁₀₋₁₈ fatty acids, such as cocomonoethanolamide. The dissolution control agent is typically included in the solid cleansing formulation in an amount of precisely or about 1, 2, 5, 10, 15, or 20 weight percent, or an amount within a range bounded by any two of these values, e.g., 1-20, 1-15, 1-10, 1-5, 2-20, 2-15, 2-10, or 2-5 wt % (by weight of the solid cleansing formulation).

### Cleaning Actives

The solid cleansing formulation may include one or more cleaning compounds, which may function as physical disruptors of accumulated films and residues and/or as antimicrobial agents. The cleaning compounds may be one or more of, for example, bleach, peroxide, peroxide bleach, monopersulfates, monoperphosphates, and quaternary alkyl ammonium salts. In some embodiments, cleaning compounds or any one or more of the above specific cleaning compounds are excluded from the solid cleansing formulation.

### pH Adjusting Compounds and Buffers

The solid cleansing formulation may include one or more pH adjusting or buffer compounds. The pH adjusting compound is typically an acid or base. The acid may be, for example, HCl, citric acid, or acetic acid. The base may be, for example, a hydroxide (e.g., NaOH) or carbonate salt (e.g., sodium carbonate). The acid or base may be present in an amount of about, for example, 1, 5, 10, or 20 wt % of the solid cleansing formulation, or an amount within a range bounded by any two of the foregoing values (e.g., 1-20, 1-10, or 1-5 wt %). Some examples of buffer compounds include trisodium citrate, ammonium citrate, ammonium chloride, ammonium acetate, dihydrogen phosphate/hydrogen phosphate, 2-amino-2-(hydroxymethyl)propane-1,3-diol (Tris), 2,2′-(Piperazine-1,4-diyl)di(ethane-1-sulfonic acid) (PIPES), 2-[4-(2-hydroxyethyl)piperazin-1-yl]ethanesulfonic acid (HEPES), and 3-morpholinopropane-1-sulfonic acid (MOPS). In other embodiments, an acid, base, or buffer compound or any one or more of the above specific acid, base, or buffer compounds is/are excluded from the solid cleansing formulation.

### Surfactants

The solid cleansing formulation may include one or more surfactants. The surfactant may be a cationic, anionic, zwitterionic, or non-ionic surfactant. Some examples of cationic surfactants include cetrimonium bromide, benzethonium chloride, cetylpyridinium chloride, dimethyldioctadecylammonium chloride, octenidine dihydrochloride, C₈₋₁₂ alkyl hydroxyethyl dimethylammonium chloride, and C₈₋₁₂ alkylamidodimethyl propylamine. Some examples of anionic surfactants include alkylbenzene sulfonates, C₁₀₋₁₆ alkyl sulfonates, C₁₀₋₁₆ alpha-olefin sulfonates, alkyl sulfates (e.g., ammonium or sodium lauryl sulfate), and aryl sulfates. Some examples of zwitterionic (amphoteric) surfactants include the betaines (e.g., cocamidopropyl betaine (CAPB) or lauramidopropyl betaine) and sultaines (e.g., lauryl sultaine). Some examples of non-ionic surfactants include alkyl polyglucosides, non-ionic fatty alcohol ethoxylates, alkyl phenol ethoxylates, and fatty acid alkoxylates. In some embodiments, the surfactants are selected from alkylbenzene sulfonates, C₁₀₋₁₆ alkyl sulfonates, C₁₀₋₁₆ alpha-olefin sulfonates, and alkyl polyglucosides.

### Fragrance

The solid cleansing formulation may include one or more fragrance compounds. A fragrance component that provides further malodor reduction or neutralization may or may not be present in the solid cleansing formulation of the present disclosure. In one aspect, the fragrance component can be a free fragrance, a fragrance precursor, a solid particulate containing at least one fragrance and a fragrance carrier (i.e., a fragrance booster), an encapsulated fragrance, or any combination thereof. In some embodiments, the solid cleansing formulation excludes a fragrance (i.e., is fragrance free).

In one aspect, the fragrance has a melting point that is in the range of from about −100° C. to about 100° C., or from about −80° C. to 80° C., or from about −20° C. to about 50° C., or from about −30° C. to about 20° C. In one aspect, the fragrance can have a melting point that is in the range of from about 25° C. to about 400° C., or from about 50° C. to about 380° C., or from about 75° C. to about 350° C., or from about 100° C. to about 330° C.

In some embodiments, the fragrance is an ester, an ether, an aldehyde, a ketone, an alcohol, a hydrocarbon, an essential oil, and a combination thereof. In one aspect, the fragrance can be, for example, adoxal (2,6,10-trimethyl-9-undecenal), anisaldehyde (4-methoxybenzaldehyde), cymal (3-(4-isopropyl-phenyl)-2-methylpropanal), ethylvanillin, florhydral (3-(3-isopropylphenyl)butanal), helional (3-(3,4-methylenedioxyphenyl)-2-methylpropanal), heliotropin, hydroxycitronellal, lauraldehyde, lyral (3- and 4-(4-hydroxy-4-methylpentyl)-3-cyclohexene-1-carboxaldehyde), methyl nonyl acetaldehyde, lilial (3-(4-tert-butylphenyl)-2-methylpropanal), phenyl acetaldehyde, undecylenaldehyde, vanillin, 2,6,10-trimethyl-9-undecenal, 3-dodecen-1-al, α-n-amylcinnamaldehyde, melonal (2,6-dimethyl-5-heptenal), 2,4-dimethyl-3-cyclohexene-1-carboxaldehyde (triplal), 4-methoxybenzaldehyde, benzaldehyde, 3-(4-tert-butylphenyl)propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]decylidene-8)butanal, octahydro-4,7-methano-1H-indenecarboxaldehyde, 3-ethoxy-4-hydroxybenzaldehyde, para-ethyl-α,α-dimethylhydrocinnamaldehyde, α-methyl-3,4-(methylenedioxy)hydrocinnamaldehyde, 3,4-methylenedioxybenzaldehyde, α-n-hexylcinnamaldehyde, m-cymene-7-carboxaldehyde, α-methyl phenylacetaldehyde, 7-hydroxy-3,7-dimethyloctanal, undecanal, 2,4,6-trimethyl-3-cyclohexene-1-carboxaldehyde, 4-(3)(4-methyl-3-pentenyl)-3-cyclohexenecarboxaldehyde, 1-dodecanal, 2,4-dimethylcyclohexene-3-carboxaldehyde, 4-(4-hydroxy-4-methylpentyl)-3-cylohexene-1-carboxaldehyde, 7-methoxy-3,7-dimethyloctan-1-al, 2-methylundecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanoindane-1- or -2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyloctanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peony aldehyde (6,10-dimethyl-3-oxa-5,9-undecadien-1-al), hexahydro-4,7-methanoindane-1-carboxaldehyde, 2-methyloctanal, α-methyl-4-(1-methylethyl)benzene acetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methyl nonyl acetaldehyde, hexanal, or trans-2-hexenal, or a combination of two or more of these.

In other embodiments, the fragrance is, for example, methyl β-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), α-damascone, β-damascone, Δ-damascone, iso-damascone, damascenone, methyl dihydrojasmonate, menthone, carvone, camphor, koavone (3,4,5,6,6-pentamethylhept-3-en-2-one), fenchone, α-ionone, β-ionone, γ-methyl ionone, fleuramone (2-heptylcyclopentanone), dihydrojasmone, cis-jasmone, Iso E Super (1-(1,2,3,4,5,6J,8-octahydro-2,3,8,8-tetramethyl-2-naphthalenyl)ethan-1-one (and isomers)), methyl cedrenyl ketone, acetophenone, methyl acetophenone, para-methoxyacetophenone, methyl β-naphtyl ketone, benzyl acetone, benzophenone, para-hydroxyphenylbutanone, celery ketone (3-methyl-5-propyl-2-cyclohexenone), 6-isopropyldecahydro-2-naphtone, dimethyl octenone, frescomenthe (2-butan-2-ylcyclohexan-1-one), 4-(1-ethoxyvinyl)-3,3,5,5-tetramethylcyclohexanone, methyl heptenone, 2-(2-(4-methyl-3-cyclohexen-1-yl)propyl)cyclopentanone, 1-(p-menthen-6(2)yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)indanone, 4-damascol, dulcinyl(4-(1,3-benzodioxol-5-yl)butan-2-one), Hexalon (1-(2,6,6-trimethyl-2-cyclohexen-1-yl)-1,6-heptadien-3-one), isocyclemone E (2-acetonaphthone-1,2,3,4,5,6,7,8-octahydro-2,3,8,8-tetramethyl), methyl nonyl ketone, methyl cyclocitrone, methyl lavender ketone, orivone (4-tert-amylcyclohexanone), 4-tert-butylcyclohexanone, delphone (2-pentyl cyclopentanone), muscone (CAS 541-91-3), neobutenone (1-(5,5-dimethyl-1-cyclohexenyl)pent-4-en-1-one), plicatone (CAS 41724-19-0), veloutone (2,2,5-trimethyl-5-pentylcyclopentan-1-one), 2,4,4,7-tetramethyloct-6-en-3-one, or tetrameran (6,10-dimethylundecen-2-one), or a combination of two or more of these.

In other embodiments, the fragrance is, for example, 10-undecen-1-ol, 2,6-dimethylheptan-2-ol, 2-methylbutanol, 2-methylpentanol, 2-phenoxyethanol, 2-phenylpropanol, 2-tert-butylcyclohexanol, 3,5,5-trimethylcyclohexanol, 3-hexanol, 3-methyl-5-phenylpentanol, 3-octanol, 3-phenylpropanol, 4-heptenol, 4-isopropylcyclohexanol,4-tert-butylcyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, 8-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylat, tetrahydrogeraniol, tetrahydrolinalool, thymol, trans-2-cis-6-nonadicnol, trans-2-nonen-1-ol, trans-2-octenol, undecanol, vanillin, champiniol, hexenol, cinnamyl alcohol, or a combination of two or more of these.

In other embodiments, the fragrance is, for example, benzyl acetate, phenoxyethyl isobutyrate, p-tert-butylcyclohexyl acetate, linalyl acetate, dimethyl benzyl carbinyl acetate (DMBCA), phenyl ethyl acetate, benzyl acetate, ethylmethylphenyl glycinate, allyl cyclohexyl propionate, styralyl propionate, benzyl salicylate, cyclohexyl salicylate, floramat, melusat, or jasmacyclat, or a combination of two or more of these.

In other embodiments, the fragrance is, for example, benzyl ethyl ether and ambroxan. The hydrocarbons include mainly terpenes, such as limonene and pinene.

In other embodiments, the fragrance is a mixture of various fragrances, which can be referred to as a perfume or perfume oil. Perfume oils of this kind can also contain natural fragrance mixtures, as are obtainable from plant sources.

In other embodiments, the fragrance is, for example, one or more essential oils, such as angelica root oil, anise oil, arnica blossom oil, basil oil, bay oil, champaca blossom oil, citrus oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, canaga oil, cardamom oil, cassia oil, pine needle oil, copaiba balsam oil, coriander oil, spearmint oil, caraway oil, cumin oil, labdanum oil, lavender oil, lemongrass oil, lime blossom oil, lime oil, mandarin oil, balm oil, mint oil, musk seed oil, muscatel oil, myrrh oil, clove oil, neroli oil, niaouli oil, olibanum oil, orange blossom oil, orange oil, origanum oil, palmarosa oil, patchouli oil, peru balsam oil, petitgrain oil, pepper oil, peppermint oil, pimento oil, pine oil, rose oil, rosemary oil, sage oil, sandalwood oil, celery oil, spike oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil and ambrettolide, ambroxan, α-amylcinnamaldehyde, anethol, anisaldehyde, anise alcohol, anisol, anthranilic acid methyl ester, acetophenone, benzyl acetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, α-bromostyrene, n-decyl aldehyde, n-dodecyl aldehyde, eugenol, eugenol methyl ether, eucalyptol, farnesol, fenchone, fenchyl acetate, geranyl acetate, geranyl formate, heliotropin, heptine carboxylic acid methyl ester, heptaldehyde, hydroquinone dimethyl ether, hydroxycinnamaldehyde, hydroxycinnamyl alcohol, indol, irone, isoeugenol, isoeugenol methyl ether, isosafrole, jasmone, camphor, carvacrol, carvone, p-cresol methyl ether, cumarin, p-methoxyacetophenone, methyl n-amyl ketone, methyl anthranilic acid methyl ester, p-methyl acetophenone, methyl chavicol, p-methyl quinoline, methyl β-naphthyl ketone, methyl n-nonyl acetaldehyde, methyl n-nonyl ketone, muscone, β-naphthol ethyl ether, β-naphthol methyl ether, nerol, n-nonyl aldehyde, nonyl alcohol, n-octyl aldehyde, p-oxy-acetophenone, pentadecanolide, β-phenyl ethyl alcohol, phenyl acetic acid, pulegone, safrole, salicylic acid isoamyl ester, salicylic acid methyl ester, salicylic acid hexyl ester, salicylic acid cyclohexyl ester, santalol, sandelice, skatole, terpineol, thymene, thymol, troenan, γ-undelactone, vanillin, veratrum aldehyde, cinnmaldehyde, cinnamyl alcohol, cinnamic acid, cinnamic acid ethyl ester, cinnamic acid benzyl ester, diphenyl oxide, limonene, linalool, linalyl acetate and propionate, melusat, menthol, menthone, methyl n-heptenone, pinene, phenyl acetaldehyde, terpinyl acetate, citral, citronellal, and mixtures thereof.

In other embodiments, the fragrance can have, for example, a musky scent, a pungent scent, a camphoraceous scent, an ethereal scent, a floral scent, a peppermint scent, or any combination thereof.

In other embodiments, the fragrance can comprise methyl formate, methyl acetate, methyl butyrate, ethyl butyrate, isoamyl acetate, pentyl butyrate, pentyl pentanoate, octyl acetate, myrcene, geraniol, nerol, citral, citronellol, linalool, nerolidol, limonene, camphor, terpineol, α-ionone, thujone, benzaldehyde, eugenol, cinnamaldehyde, ethyl maltol, vanillin, anisole, anethole, estragole, thymol, indole, pyridine, furaneol, 1-hexanol, cis-3-hexenal, furfural, hexyl cinnamaldehyde, fructone, hexyl acetate, ethyl methyl phenyl glycidate, dihydrojasmone, oct-1-en-3-one, 2-acetyl-1-pyrroline, 6-acetyl-2,3,4,5-tetrahydropyridine, γ-decalactone, γ-nonalactone, Δ-octalone, jasmine lactone, massoia lactone, wine lactone, sotolon, grapefruit mercaptan, methanthiol, methyl phosphine, dimethyl phosphine, nerolin, 2,4,6-trichloroanisole, or any combination thereof.

In other embodiments, the fragrance can comprise a linear terpene, a cyclic terpene, an aromatic compound, a lactone, a thiol, or any combination thereof.

In other embodiments, the fragrance can be a fragrance precursor. “Fragrance precursor” refers to compounds which only release the actual fragrance following chemical conversion/separation, for example, when exposed to light or other environmental conditions, such as pH, temperature, etc. Compositions of this kind are often referred to as pro-fragrances. In other embodiments, the fragrance component can be a free fragrance, a fragrance precursor, a fragrance booster, an encapsulated fragrance, or any combination thereof.

In some embodiments, the fragrance is an encapsulated fragrance with or without the fragrance booster. In embodiments, the encapsulated fragrance includes at least one fragrance encapsulated, for example, in a microcapsule or a nanocapsule. The microcapsules and nanocapsules can be water-soluble or water-insoluble. In one aspect, all of the fragrance is encapsulated. Examples of encapsulated fragrances are described in, for example, U.S. Pat. Nos. 6,024,943, 6,056,949, 6,194,375, 6,458,754 and 8,426,353, and US 2011/0224127 A1, each of which is incorporated by reference in its entirety. In some embodiments, an encapsulated fragrance is excluded from the solid cleansing formulation.

In embodiments, the fragrance component (e.g., fragrance booster and/or encapsulated fragrance) is present in the solid cleansing formulation in an amount from about 0.1 percent by weight to about 25.0 percent by weight, or from about 0.1 percent by weight to about 20 percent by weight, or from about 0.5 percent by weight to about 20 percent by weight, or from about 0.5 percent by weight to about 15 percent by weight, or from about 1 percent by weight to about 15 percent by weight, or from about 1 percent by weight to about 12 percent by weight, or from about 1.0 percent by weight to about 5% by weight, or from about 3 percent by weight to about 12 percent by weight, based on the total weight of the solid cleansing formulation. In some embodiments, the solid cleansing formulation excludes a fragrance (i.e., is fragrance free).

### Colorant(s)

In embodiments, the solid cleansing formulation of the present disclosure includes at least one colorant (dye). The colorant may be, for example, a water-soluble polymer, water-insoluble polymer, a water-soluble dye, a water-insoluble dye, or a combination thereof. The colorant(s) may be, for example, red, orange, yellow, blue, indigo, violet, or any combination thereof. In one aspect, the colorant(s) can be present in an amount of from about 0.0001% by weight to about 2.0% by weight, or from about 0.0001% by weight to about 1.5% by weight, or from about 0.0001% by weight to about 1.0% by weight, or from about 0.0001% by weight to about 0.5% by weight, or from about 0.001% by weight to about 0.3% by weight, or from about 0.001% by weight to about 0.1% by weight, or from about 0.001% by weight to about 0.05% by weight, or from about 0.001% by weight to about 0.025% by weight, or about 0.001% by weight, or about 0.002% by weight, or about 0.003% by weight, or about 0.0035% by weight of the solid cleansing formulation. In some embodiments, the solid cleansing formulation excludes a colorant (i.e., is dye free).

### Optional Additional Agents or Compounds

In some embodiments, the solid cleansing formulation contains a simple salt that may function to maintain the structural integrity or stability of the formulation. The simple salt may be, for example, a sulfate (e.g., sodium or potassium sulfate), carbonate (e.g., sodium or potassium carbonate), acetate (e.g., sodium or potassium acetate), formate (e.g., sodium formate), phenolate, or halide (e.g., sodium or potassium chloride or bromide). The simple salt may be present in an amount of about, for example, 1, 2, 5, 10, 20, 30, 40, 50, 60, or 70 wt % of the solid cleansing formulation, or an amount within a range bounded by any two of the foregoing values (e.g., 10-70 or 20-60 wt %). In other embodiments, the solid cleansing formulation contains an amine, such as monoethanolamine (MEA). In other embodiments, a simple salt or an amino acid is excluded, or an amine (or more particularly, MEA) is excluded. In some embodiments, to further ensure shape integrity of the solid cleansing formulation, the solid cleansing formulation may include a cross-linking agent, such as boric acid or sodium borate. In other embodiments, a crosslinking agent is excluded.

### Methods of Preparation

In another aspect, the present disclosure is directed to a method of making the solid cleansing formulation. Generally, selected amounts of the cyclic dextrin, binder, and optionally, one or more dissolution control agents, one or more surfactants, one or more pH adjusters or buffers, one or more cleaning actives, fragrances, and/or colorants, such as any of those described above, are homogeneously blended to produce the solid cleansing formulation. The components can be blended by any of the suitable methods known in the art, such as by molding, casting, extruding, or blowing. The blend is then typically compressed and optionally cut into shapes suitable for use in a toilet tank. A fastening device, such as a clip, for hanging onto the tank, may or may not be attached to the compressed blend.

### METHODS OF USE

In another aspect, the present disclosure is directed to a method of using the solid cleansing formulation. In the method, the solid cleansing formulation (typically in the shape of a tablet, block, or bar) is placed in contact with water held in the toilet tank or toilet bowl. In one embodiment, the solid cleansing formulation is simply dropped into the tank with no means of suspending the formulation in the tank. In another embodiment, the solid cleansing formulation is suspended into the tank by means of a clip or other fastening device with one end attached to the solid formulation and the other end capable of fastening to the tank. With the solid cleansing formulation in contact with the water in the tank, the solid cleansing formulation is designed to slowly dissolve over time, which permits the steady release of the cyclic dextrin into the toilet bowl over numerous flushes to suppress bathroom malodor over time. In another embodiment, the solid cleansing formulation is clipped or otherwise affixed to the inside portion of the toilet bowl and positioned appropriately to permit wetting and partial dissolution with each flush.

### Exemplary Formulations

Formulations (abbreviated as Formula) are set forth in Tables 1 and 2 below.

TABLE 1

| | Formula 1 | | | | |
|---|---|---|---|---|---|
| | (Comparative) | Formula 2 | Formula 3 | Formula 4 | Formula 5 |
| Raw material | % | % | % | % | % |
| Blend of (1) Sodium | 55.56 | 55.46 | 55.06 | 54.56 | 53.56 |
| dodecylbenzene | | | | | |
| sulfonate, (2) sodium | | | | | |
| C14-16 alpha-olefin | | | | | |
| sulfonate and (3) | | | | | |
| alkyl polyglucoside | | | | | |
| Blend of (1) Sodium | 51.34 | 51.34 | 51.34 | 51.34 | 51.34 |
| Sulfate, (2) Sodium | | | | | |
| Carbonate, (3) | | | | | |
| Trisodium Citrate | | | | | |
| Highly Branched | 0.00 | 0.10 | 0.50 | 1.00 | 2.00 |
| Cyclic Dextrin | | | | | |
| Fragrance | 3.10 | 3.10 | 3.10 | 3.10 | 3.10 |
| Total | 100.00 | 100.00 | 100.00 | 100.00 | 100.00 |

TABLE 2

| | Formula | Formula | Formula | Formula | Formula | Formula | Formula |
|---|---|---|---|---|---|---|---|
| | 6 | 7 | 8 | 9 | 10 | 11 | 12 |
| Raw Materials | % | | | | | | |
| Sodium Sulfate | Balance | Balance | Balance | Balance | Balance | Balance | Balance |
| | to 100 | to 100 | to 100 | to 100 | to 100 | to 100 | to 100 |
| Blend of (1) | 40 | 40 | 40 | 40 | 40 | 40 | 40 |
| Alkylbenzene | | | | | | | |
| sulfonate-Na C10-13, | | | | | | | |
| (2) Olefinsulfonate-Na | | | | | | | |
| C14-16 and (3) Alcohol | | | | | | | |
| ethoxylate C16-18 | | | | | | | |
| 25EO | | | | | | | |
| Blend of (1) Sodium | 3 | 3 | 3 | 3 | 3 | 3 | 3 |
| Carbonate, (2) Sodium | | | | | | | |
| Citrate and (3) Silicate | | | | | | | |
| Blend of (1) Water and | 2.6 | 2.6 | 2.6 | 2.6 | 2.6 | 2.6 | 2.6 |
| (2) Dipropylene Glycol | | | | | | | |
| Fragrance | 1 | 1 | 1 | 1 | 1 | 1 | 1 |
| Highly Branched Cyclic | 0 | 0.1 | 0.5 | 1 | 2 | 5 | 10 |
| Dextrin | | | | | | | |
| Total | 100 | 100 | 100 | 100 | 100 | 100 | 100 |

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A solid slow-release formulation effective as a toilet cleanser, comprising a highly branched cyclic dextrin and a binder.

2. The formulation of claim 1, wherein the solid slow-release formulation is suspended on a clip made to hang in a toilet tank.

3. The formulation of claim 1, wherein the solid slow-release formulation is a compressed tablet or block.

4. The formulation of claim 1, wherein the binder comprises hydroxyethylcellulose.

5. The formulation of claim 1, wherein the binder is selected from the group consisting of sodium sulfate, sodium carbonate, trisodium citrate, C₁₀₋₁₆ linear alkyl sulfonates, C₁₀₋₁₆ linear alkyl-benzene sulfonates, and combinations thereof.

6. The formulation of claim 1, further comprising a dissolution control agent.

7. The formulation of claim 6, wherein the dissolution control agent is a monoalkanolamine.

8. The formulation of claim 1, further comprising a cleaning active.

9. The formulation of claim 8, wherein the cleaning active is selected from the group consisting of bleach, peroxide, and peroxide bleach.

10. The formulation of claim 1, further comprising a fragrance component.

11. The formulation of claim 1, further comprising a colorant.

12. The formulation of claim 1, further comprising a surfactant.

13. The formulation of claim 12, wherein the surfactant is a cationic surfactant.

14. The formulation of claim 12, wherein the surfactant is an anionic surfactant.

15. The formulation of claim 12, wherein the surfactant is a non-ionic surfactant.

16. The formulation of claim 12, wherein the surfactant is selected from the group consisting of alkylbenzene sulfonates, C₁₀₋₁₆ alkyl sulfonates, C₁₀₋₁₆ alpha-olefin sulfonates, and alkyl polyglucosides.

17. The formulation of claim 1, further comprising a pH adjusting compound.

18. The formulation of claim 17, wherein the pH adjusting compound comprises a carbonate salt.

19. The formulation of claim 1, further comprising a pH buffer.

20. The formulation of claim 19, wherein the pH buffer comprises trisodium citrate.
